(19) United States
(12) Patent Application Publication
(10) Pub. No.: US 2006/0190850 A1
(43) Pub. Date: Aug. 24, 2006

(54) Method for optimizing the geometry of structural elements of a circuit design pattern and method for producing a photomask

(76) Inventors: Roderick Kohle, Ottobrunn (DE); Burkhard Ludwig, Munchen (DE); Michael Heissmeier, Munchen (DE); Armin Semmler, Munchen (DE); Dirk Meyer, Saffron Walden (GB); Christoph Nolscher, Nurnberg (DE); Jorg Thiele, Vatersetten (DE)

Correspondence Address: EDELL, SHAPIRO & FINNAN, LLC, 1901 RESEARCH BLVD., SUITE 400, ROCKVILLE, MD, 20850, US

(21) Appl. No.: 11/348,549

(22) Filed: Feb. 7, 2006

(30) Foreign Application Priority Data
Feb. 7, 2005 (DE) 102005005591.5

(51) Int. Cl. G06F 17/50

(52) U.S. Cl. 716/2; 716/21; 716/4

(57) ABSTRACT

A method for optimizing the geometry of structural elements of a circuit pattern involves providing an overall circuit pattern of the circuit design and a plurality of basic patterns. Subsequently, the circuit pattern of the circuit design is iteratively decomposed into corresponding basic patterns in order to classify those parts of the circuit pattern of the plurality of structural elements wherein there exists a match with the basic pattern. Subsequently, further basic patterns are determined for those parts of the circuit pattern which were not previously classified. After applying a specification for optimizing the geometry of the structural elements, the optimized basic patterns are inserted into the circuit design thus achieving an improvement of the optical imaging properties.

### CROSS REFERENCE TO RELATED APPLICATIONS

This application claims priority under 35 USC §119 to German Application No. DE 102005005591.5, filed on Feb. 7, 2005, and titled “Method for Optimizing the Geometry of Structure Elements of a Pattern of a Circuit Design for an Improvement of the Optical Imaging Properties and Use of the Method for Producing a Photomask,” the entire contents of which are hereby incorporated by reference.

### FIELD OF THE INVENTION

The invention relates to a method for optimizing the geometry of structural elements of a pattern of a circuit design for an improvement of the optical imaging properties, in particular in the photolithographic projection of a pattern formed on a photomask onto a substrate of a semiconductor wafer. The invention furthermore relates to the method for producing a photomask.

### BACKGROUND

For the production of integrated circuits, layers provided with different electrical properties are usually applied on semiconductor wafers and patterned lithographically in each case. A lithographic patterning step may include: applying a photosensitive resist, exposing the photosensitive resist with a desired structure for the relevant plane, developing the photosensitive resist, and transferring the resist mask into the underlying layer in an etching step.

For the step of lithographic projection of a circuit pattern, a wafer scanner or wafer stepper is commonly used as an exposure apparatus. In the exposure apparatus, the photosensitive resist is exposed with electromagnetic radiation having a predetermined wavelength, which lies in the UV range for example.

Each individual layer of the circuit pattern is commonly imaged onto the semiconductor wafer by a special mask (also called a reticle) and an optical projection system. The reticle comprises a substrate layer provided with absorbing elements, such as, e.g., a chromium layer, which simulates the circuit pattern. The optical projection system of the exposure apparatus often comprises a plurality of lenses and diaphragms and often effects a reduction of the circuit pattern in the course of transfer onto the resist layer.

Dense line-gap patterns such as those formed for instance in the area of the production of dynamic random access memories (DRAM) have feature sizes of 70, 90 or 110 nm, for example. In the process for lithographic exposure of such a pattern, wavelengths of 248 nm or 193 nm are currently used in exposure apparatus.

The attainable structure resolution is influenced by a number of factors. Thus, in optical lithography in the production of integrated circuits, the relationship between attainable limiting resolution bₘᵢₙ and the influencing variables of the projection is described by Rayleigh's law of microscopy:
bₘᵢₙ=k₁*λ/NA.

The limiting resolution bₘᵢₙ of a line grating is accordingly dependent on the technology factor k₁, the exposure wavelength λ and the numerical aperture NA of the lens of the exposure apparatus. The limiting resolution bₘᵢₙ in this case corresponds to half the period of the line grating to be imaged.

While the exposure wavelength λ and the maximum value of the numerical aperture NA are fixed for a specific generation of exposure apparatuses, by optimizing the exposure process and using so-called RET concepts (RET=resolution enhancement techniques), it is possible to reduce the technology factor k₁ and thus improve the limiting resolution.

In this case it has been found, inter alia, that a shortening of lines to be imaged at their ends and also an altered line width occur. In order to minimize the inaccuracies resulting from these effects during the lithographic projection, critical structural elements are often provided with so-called OPC structures. OPC structures (OPC=optical proximity correction) alter the form or dimensions of specific structural elements at specific locations of the circuit pattern, or are additional structures not imaged in the photoresist.

OPC structures serve for altering the line width of specific structural elements of the circuit pattern, so that it is possible to compensate for specific imaging errors when the circuit pattern is transferred into a resist layer of a semiconductor wafer. It is a goal, through the use of OPC structures, to improve the image contrast and the depth of focus during the photolithographic projection. OPC structures are also referred to as serifs or “hammerheads”. The targeted alteration of line widths is likewise included in this.

The addition of fine structural elements, also referred to as “sub-resolution-sized assist features” or “scattering bars”), which are below the resolution limit of the exposure apparatus, is not usually assigned to the OPC process flow, but rather may be considered together with the choice of the optimized exposure conditions of the exposure apparatus as an independent measure for enhancing resolution.

In order to determine the OPC structures, the circuit pattern is usually calculated using a simulation model of the photolithographic projection which results in the event of imaging onto the resist layer of the semiconductor wafer. A simulation model which calculates the physicochemical processes during the lithography by means of a two-dimensional model is often used for this purpose. These calculations have to be performed for virtually the entire area of the reticle in order to be able to calculate the OPC structures for the entire chip to be produced. In the process flow for determining the OPC structures, an optimization of the geometry of the mask structures and, if appropriate, an optimization of further lithography parameters, such as, for example, the choice of the exposure conditions in the projection apparatus, are usually performed on the basis of these simulations.

The publication by N. Cobb, “Fast Optical and Process Proximity Correction Algorithms for Integrated Circuit Manufacturing”, Doctoral thesis, University of California, Berkeley (USA), 1998, provides a historical summary of the development of the various concepts for determining OPC structures.

Thus, a (“manual”) optimization of the geometries of the mask structures, controlled by a layout engineer, was often carried out in older methods. In this case, the resist patterns formed on the semiconductor wafer during an exposure are used as prescribed values for a targeted alteration of the geometries of the mask structures that is essentially based on the layout engineer's experience.

The concept of the “manual” optimization of the geometries of the mask structures is extended in so-called rule-based OPC techniques to the effect that specific geometric structures are sought in a layout and are subsequently altered on the basis of prescribed rules. This procedure permits the automatic determination of the OPC structures by special layout programs. In modern semiconductor components, the number of structural elements to be imaged is so large that cost-effective determination of the OPC structures can only be effected automatically.

So-called model-based OPC simulation is described as a further possibility on pages 11 to 12 of the publication by N. Cobb. In this case, the imaging of the structural elements of the photomask onto a resist layer applied on the semiconductor wafer is calculated by a simulation model. The calculation requires not only a model of the optical imaging for the calculation of the aerial image but also models of the resist exposure, the photomask, and etching processes. The simulation result is fed back to the layout program in order to alter the geometric structures on the mask. For altering the structural elements, the latter are divided (fragmented) into individual partial structures. The geometric structures are optimized for each of these fragments, the optimization being described as feedback of the simulation result.

In lithography simulation refined and more complex computational methods which enable modeling and calculation to be effected as realistically as possible have been implemented in recent years. In this case, the aforementioned concept of model-based or rule-based OPC simulation is extended to the effect that not only are the edges of the structural elements (or the fragments thereof) optimized toward a target dimension during the imaging, but the imaging problem is described by a complete formulation as a numerical optimization problem. The result of the optimization is provided as the optimized mask layout, the required auxiliary structures being generated as a result of the optimization process as far as possible independently of the geometry of the initial mask. This procedure is referred to hereinafter as “advanced OPC”. An essential difference with respect to the aforementioned methods is that the concepts presented have not as yet been integrated into a commercially available process flow for determining OPC structures.

One example of an “advanced OPC” concept is described in the publication by A. Rosenbluth et al., “Optimum Mask and Source Patterns to Print a Given Shape”, Proceedings of SPIE vol. 4346 (2001), pages 486 to 502, where in addition to the geometry of the structural elements of the mask, the exposure source is also optimized by virtue of a corresponding pupil aperture being calculated. The joint optimization permits a substantial enlargement of the process window.

The publication by A. Erdmann et al., “Mask and Source Optimization for Lithographic Imaging Systems”, Proceedings of SPIE vol. 5182 (2003), pages 88 to 102, describes a genetic algorithm in which a non-analytical global optimization is performed proceeding from an analytical optimization function (“merit function”) comprising the weighted contributions of the linewidth deviation, the gradient of the intensity profiles, the higher-order light diffractions, and the total number of mask structural elements.

The publication by R. Socha et al., “Contact Hole Reticle Optimization by Using Interference Mapping Lithography”, Proceedings of SPIE vol. 5377 (2004), pages 222 to 240, likewise describes an example of an “advanced OPC” concept. This method involves optimizing the arrangement of auxiliary structures for contact holes that are below the resolution limit of the projection apparatus. This is done by calculating intensity distributions of interference patterns generated by a mask for coherent and partially coherent light sources. These intensity distributions are subsequently examined for regions in which light from the projection apparatus interferes destructively or constructively. Through the arrangement of transparent or phase-shifting auxiliary structures in the destructively or constructively interfering regions, the aerial image is influenced in a targeted manner in order to achieve a high imaging fidelity.

Consequently, according to the prior art, on the one hand less precise procedures such as, e.g., the rule-based and model-based OPC methods are known. The “advanced OPC” concepts are primarily theoretical studies which, although they yield improved results, require a long execution time for an implementation in a layout software on account of the complicated calculations. The improved models in accordance with the complete optimization approaches are thus very time-consuming, so that an application to larger areas would be difficult.

Consequently, in the art there is a need for positioning OPC structures via an automatic method in a manner that saves time with regard to the computational complexity. One possibility for reducing the computational time is to take account of the hierarchy of the circuit layout in determining the OPC structures. Present-day simulation programs for determining OPC structures, such as, e.g., the caliber simulator from the company Mentor Graphics, which is based on the publication by N. Cobb, utilize the hierarchy of the circuit layout within certain limits by virtue of a specific layout cell that is positioned repeatedly in the circuit design being processed only once.

A method for classifying errors within a layout of a semiconductor circuit is disclosed in DE 10224417 A1 by the same applicant. This document describes that, for the purpose of classification, first, the layout of the semiconductor circuit is examined for contravention of predetermined design rules for the purpose of ascertaining errors. Subsequently, for each error, the latter is marked in the layout, and items of information about the error and also the layout in a vicinity of the error are extracted. Subsequently, the extracted items of information are compared with previously stored items of information within a multiplicity of classes and the error is assigned to the respective classes on the basis of the compared information. Although this method permits the possibility of examining a layout independently of the actual hierarchy, it is restricted to the case of layout verification.

### SUMMARY

The invention provides a method for improving the optical imaging properties of a pattern of a circuit design which overcomes the problems mentioned above. According to an exemplary embodiment, a method for optimizing the geometry of structural elements of a circuit pattern of a circuit design for improvement of the optical imaging properties comprises: (a) providing an electronically stored circuit pattern of the circuit design, the circuit pattern comprising a plurality of structural elements; (b) providing a plurality of basic patterns, wherein individual ones of the basic patterns comprise a specific number of structural elements in a specific arrangement as geometric primitives; (c) iteratively decomposing the circuit pattern into corresponding basic patterns by progressively performing the following for each basic pattern: defining a working region by determining external dimensions of the geometric primitives of the basic pattern; defining a surrounding region that completely surrounds the working region; comparing the basic pattern with parts of the circuit pattern in the working region and examining the surrounding region to determine whether further structural elements lie in the surrounding region; and classifying those parts of the circuit pattern in which a match exists with the basic pattern and no structural elements lie in the surrounding region that influence a lithographic projection of the circuit pattern lying in the working region; (d) determining further basic patterns based on those parts of the circuit pattern not previously classified, thus obtaining a fully classified circuit pattern; (e) applying a specification for optimizing the geometry of the structural elements of each basic pattern; and (f) inserting optimized basic patterns into the circuit design to improve of the optical imaging properties of the circuit pattern transferred onto a semiconductor wafer via lithographic projection.

According to the invention, a pattern of a circuit design is decomposed into a set of basic patterns wherein the individual ones are subjected independently to an optimization with regard to the geometries of the structural elements. On the basis of this procedure, account is taken not only of the hierarchy of the circuit design as is known for example from the arrangement of different individual layout cells, but also of structural elements lying in the surrounding window which, in the case of a lithographic projection, influence that part of the pattern which lies in the working region. Consequently, the optimized structural elements are determined for each individual basic pattern identified in the circuit design and inherently comprises a dedicated arrangement of structural elements that is to be optimized independently. Through progressive classification, a first operation involves searching for the basic patterns provided in the circuit design. Subsequently, the remaining part of the circuit design, which comprises partial patterns of structural elements not previously assigned to a basic pattern, is assigned to further basic patterns. Consequently, the optimization no longer has to be carried out on a large-area part of the circuit design, but rather in time-saving fashion only for individual each basic pattern.

In one preferred embodiment, providing the electronically stored pattern of the circuit design comprises the fact that the structural elements of the pattern comprise geometric elements of a photomask for single or a plurality of exposures or structural elements of a plurality of masks which, in progressive exposures in the case of a lithographic projection, are superposed to form an overall image.

In accordance with this procedure, the method can be extended to lithography concepts comprising not only circuit designs, which permit a direct assignment of the structural elements of the pattern with the image to be obtained in the case of the lithographic projection, but also to patterns which have to be optimized simultaneously by a plurality of exposure techniques on at least one mask.

In a further preferred embodiment, providing the basic patterns comprises: searching for parts of the pattern which recur in the overall pattern of structural elements; and creating basic patterns based on the recurring parts of the pattern.

In accordance with this procedure, a set of basic patterns is created which is as compact as possible and which utilizes the regularity of structural elements of the overall circuit pattern of the circuit design.

In a further preferred embodiment, creating basic patterns is performed based on rules which are stored in a program in a data processing system.

For different circuit designs, the patterns of structural elements may have certain similarities, such that the basic patterns, that have been previously created, might possibly be employed for another design. By storing the basic patterns in a database, it is thus possible to have recourse to particularly recurrent structures without having to provide a completely new set of basic patterns at the beginning of the method.

In a further preferred embodiment, comparing the basic pattern with parts of the overall circuit pattern in the working region comprises subjecting the basic pattern to a geometric transformation where a match is absent and again performing the comparison with the transformed basic pattern.

Specific partial patterns of structural elements often differ only with regard to their positioning in the circuit design, but can be converted into one another by geometric transformations. In accordance with this procedure, symmetrical partial patterns of the circuit design are assigned only to a single basic pattern, the search for basic patterns in the circuit design being performed progressively for all possible geometric transformations in order to identify a possible match.

In a further preferred embodiment, the geometric transformation comprises a mirroring of the basic pattern at an axis of symmetry or a rotation through a predetermined angle. Circuit designs often have cells which are arranged multiply as hierarchical basic structures. In this case, the individual cells are arranged for example such that they are rotated or mirrored at different locations. In accordance with this procedure, mirror-symmetrical and rotationally symmetrical partial patterns of the cells of the circuit design are assigned only to a single basic pattern.

In a further preferred embodiment, classifying the parts of the circuit pattern comprises marking those parts wherein exists a match with the basic pattern in the circuit design. In accordance with this procedure, it is possible, when searching for the basic patterns, to ascertain in a simple manner whether the examined part of the pattern of the plurality of structural elements has already been assigned to a basic pattern.

In a further preferred embodiment, classifying the parts of the circuit pattern of the plurality of structural elements comprises removing those parts for which a match exists with the basic pattern in the circuit design. In accordance with this procedure, the searching for the basic patterns is restricted to that part of the circuit pattern of the plurality of structural elements for which no basic patterns have been assigned.

In a further preferred embodiment, providing the electronically stored overall pattern of the circuit design comprises representing contact hole openings for an integrated circuit as structural elements of the overall pattern. Contact hole openings often have the same dimensions within a circuit design for a layout plane, but are positioned in a plurality of different arrangements with respect to one another. In modern semiconductor fabrication technologies, contact hole openings are provided with dimensions such that, without an optimization of their geometry, imaging errors would occur therefore making it more difficult or impossible to produce the integrated circuit. In accordance with this embodiment, the plurality of contact hole openings are classified into specific basic patterns and subsequently optimized with regard to their imaging properties. Consequently, the yield increases in the production of integrated circuits, meanwhile the determination of the optimized geometries only having to be carried out for the basic patterns of the respective circuit design, which significantly reduces the computational time during the optimization.

In a further preferred embodiment, iteratively decomposing the pattern of the circuit design, for each basic pattern the working regions are defined such that the working regions for all parts of the circuit design which match a basic pattern do not overlap. In accordance with this procedure, it is ensured that each structural element of the pattern of the circuit design is unambiguously assigned to a basic pattern during the decomposition.

In a further preferred embodiment, applying a specification for improving the transfer of the pattern of the circuit design onto a semiconductor wafer, in the case of a lithographic projection, comprises determining OPC structures, auxiliary structures or both auxiliary structures and OPC structures.

In order to improve the transfer of the pattern of the circuit design onto the semiconductor wafer during the lithographic projection, OPC structures are often employed to compensate for specific imaging errors. The OPC structures are now calculated not for the complete circuit design, but exclusively for the individual basic patterns. Thus, computational complexity in the determination of the OPC structures is significantly reduced as a result.

In a further preferred embodiment, determining the OPC structures comprises optimizing the structure-imparting edges of the structural elements of each basic pattern. In accordance with this procedure, an optimization of the structure-imparting edges of the structural elements is carried out, leading to an improvement of the transfer of the circuit design pattern onto the semiconductor wafer during lithographic projection.

In a further preferred embodiment, the structure-imparting edges of the structural elements of each basic pattern are determined by a rule-based OPC optimization. In accordance with this procedure, an OPC optimization implemented in commercial simulation programs is applied to the basic patterns, resulting in saving computational time as compared to that of a circuit design which has not been decomposed into basic patterns.

In a further preferred embodiment, the structure-imparting edges of the structural elements of the individual ones of the basic pattern are determined by employing a model-based OPC optimization. In accordance with this procedure, an OPC optimization implemented in commercial simulation programs is likewise applied to the basic patterns effecting improved results, in comparison with a rule-based OPC optimization, during the transfer onto a semiconductor wafer.

In a further preferred embodiment, the determination of the structure-imparting edges of the structural elements of each basic pattern is described as a numerical optimization problem of an imaging, in the case of a lithographic projection, in order to carry out the optimization for altering the geometry of the structural elements of each basic pattern. In accordance with this procedure, an OPC optimization is performed which was not possible in previous simulation programs on account of the long calculation times. Consequently, the invention can be combined with a plurality of newer OPC models which, in comparison with previous procedures, could not be applied to larger circuit patterns.

In a further preferred embodiment, the following is further performed: providing a simulation program of the optical imaging in the case of a lithographic projection onto a resist layer applied on a semiconductor wafer; applying the simulation program of the optical imaging for individual ones of the basic patterns in order to determine an intensity profile of an aerial image for the resist layer; comparing the intensity profile with the structural elements of the basic pattern ascertaining whether the intensity lies below a specific threshold in regions that are to be imaged dark for auxiliary structural elements that are to be inserted in regions which lie above the threshold; providing non-imaging auxiliary structures for individual ones of the structural elements of the basic patterns whose intensity profile lies above the threshold; comparing the intensity profile with the structural elements of the basic pattern ascertaining whether the intensity lies above a specific threshold in regions that are to be imaged bright for auxiliary structural elements that are to be inserted in regions which lie below the threshold; providing further non-imaging auxiliary structures for each structural element of the basic pattern whose intensity profile lies below the threshold; optimizing the non-imaging auxiliary structures with regard to the dimensions and the position with respect to the associated structural element of the basic pattern; and inserting the optimized non-imaging auxiliary structures into the basic pattern.

In accordance with this procedure, the intensity profile at the position of the resist layer is additionally calculated besides an optimization of the geometry of the structural elements. From this intensity profile, those structural elements are subsequently determined which, in the case of a lithographic projection, would not be imaged with the envisaged intensity due to diffraction phenomena. Non-imaging auxiliary structures are inserted at these locations in order to correct the intensity profile. On the basis of this procedure, the pattern of the circuit design which is decomposed into basic patterns is additionally provided with non-imaging auxiliary structures that are normally not determined in the context of an OPS correction. Thus, another advantage is that it is possible for a modification of the pattern of the circuit design to be performed with a low expenditure of computational time.

In a further preferred embodiment, optimizing the geometry of the structural elements of the basic pattern comprises: calculating error vectors for individual ones of the structural elements of the basic pattern in regards to the comparison of the intensity profile with the structural elements of the basic pattern, thus determining an error distance and an error gradient; and optimizing the geometry of the structural elements of the basic pattern on the basis of a minimization of the error vectors. In accordance with this procedure, besides the correction with non-imaging auxiliary structures, the intensity profile is employed for the calculation of OPC structures by determining error vectors on the basis of which the geometry of the structural elements of the basic pattern is optimized.

In a further preferred embodiment, the non-imaging auxiliary structures are furthermore determined as a function of an intensity fluctuation, a defocus aberration in a projection apparatus and/or a variation of the production-dictated fluctuations of the mask geometry of a photomask.

In accordance with this procedure, production- and exposure-apparatus-dependent variations in the case of a lithographic projection are taken into account as early as during the determination of the auxiliary structure features, in particular in order to enlarge the process window of the corresponding production technology.

In a further preferred embodiment, the non-imaging auxiliary structures are furthermore determined with regard to their minimum size or their minimum distance with respect to structural elements.

In accordance with this procedure, requirements made of the application technology of the photomasks are taken into account as early as during the determination of the auxiliary structure features ensuring the producibility of the photomask with the auxiliary structure features.

The method according to the invention proves to be particularly advantageous in the use for producing a photomask, all of the optimized basic patterns being stored in order to form an optimized pattern of the circuit design, and the stored pattern subsequently being transferred onto a mask.

In accordance with this procedure, the specific OPC structures or auxiliary structure features can be employed with different types of masks, e.g., binary masks comprising a transparent mask substrate and an absorbing (black) chromium layer, alternating phase shift masks, CPL masks or tritone masks.

### BRIEF DESCRIPTION OF THE DRAWINGS

FIG. 1 shows an exposure apparatus in a schematic cross-sectional view for application of the method according to an exemplary embodiment of the invention.

FIG. 2 presents a flowchart displaying the sequence of the method according to the invention.

FIG. 3 illustrates a plan view of a pattern of a circuit design in the application of the method according to the invention;

FIG. 4 illustrates a plan view of a detail from a circuit design in the application of the method according to the invention; and

FIG. 5 presents a diagram of an intensity distribution in the application of the method according to the invention.

### DETAILED DESCRIPTION

The method according to the invention is described below for an optimization of the geometry of structural elements of a pattern of a circuit design thus improving the optical imaging properties during the production of integrated semiconductor circuits. The application of the method for a contact hole plane of the circuit design is explained by way of example. However, the invention can also be applied to other circuit planes having a different functionality. However, it is also conceivable to employ the invention during the lithographic patterning of layers of other semiconductor components, for example during the production of logic circuits, random access memory components (DRAM) or the like.

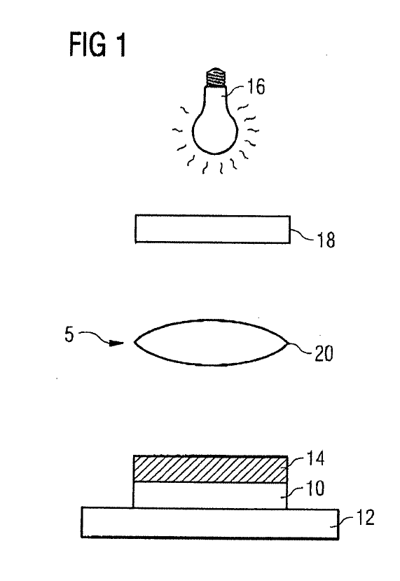

FIG. 1 shows the construction of an exposure apparatus or projection apparatus 5 in a schematic cross-sectional view. The projection apparatus 5 comprises a moveable substrate holder 12. A semiconductor wafer 10 is placed on the substrate holder 12, a resist layer 14 being applied to the semiconductor wafer on a front side for example via spinning-on.

The projection apparatus 5 furthermore comprises a light source 16, which is arranged above the substrate holder 12 and is suitable for emitting light for example having a wavelength of 248 nm, 193 nm or 157 nm. The light emitted by the light source 16 is projected through a projection objective 20 onto the surface of the semiconductor wafer 10.

A reticle 18 provided with the pattern 22 of structural elements 24 is fitted between the light source 16 and the projection objective 20. In the case of a wafer scanner, an exposure slot is fitted between the reticle 18 and the projection objective 20 (not shown in FIG. 1). By controlling the substrate holder 12, the front side of the semiconductor wafer 10 is progressively patterned in individual exposure fields.

A circuit design having a contact hole plane with extremely small dimensions, e.g., of 100 nm or less, is provided for the pattern.

The method according to the invention is explained below as part of an OPC process flow for the calculation of OPC structures for the contact hole plane of a circuit pattern. However, the method according to the invention is also suitable for other calculations which require a simulation of a large-area circuit pattern provided with many recurring structural elements.

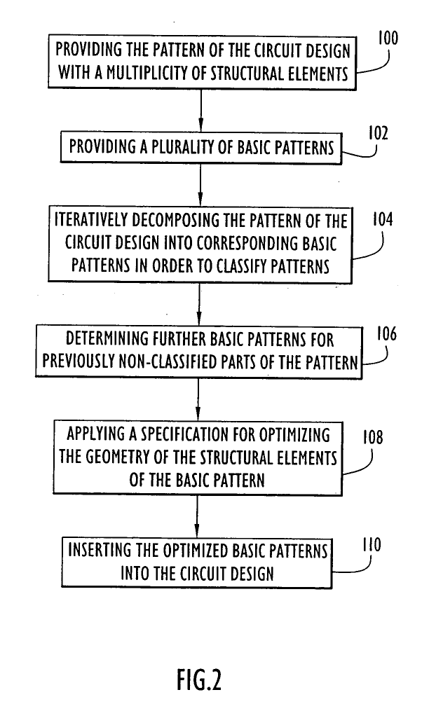

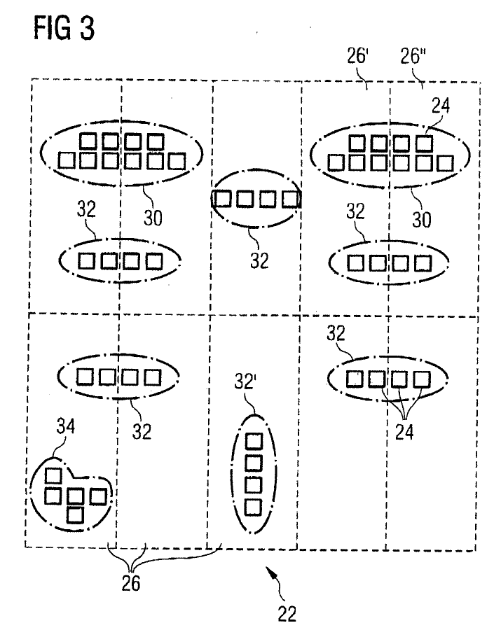

FIG. 2 shows one embodiment of the method according to the invention in a flowchart. Operation 100 involves providing a pattern of the circuit design, the pattern being stored in a layout program in electronic form. FIG. 3 illustrates an example of an overall pattern 22 of a circuit design. In FIG. 3, the overall pattern 22 comprises the contact hole plane and a plurality of structural elements 24. The individual structural elements 24 are formed as square openings. This circuit design usually originates from a hierarchy construction comprising individual cells 26, which are indicated as dashed lines in FIG. 2. It is evident that structural elements 24 of adjacent cells 26′ and 26″ that are actually identical apart from a mirroring about a vertical axis of symmetry would influence one another in the case of projection with the projection apparatus 5. Accordingly, it is necessary to take account of individual cells 26, in the determination of OPC structures, in addition to analyzing the entire circuit design.

In the exemplary embodiment in accordance with FIG. 2, the structural elements 24 of the pattern 22 are shown as square openings for which there is a direct assignment between the pattern to be obtained in the case of lithographic projection on the resist layer 14 of the semiconductor wafer 10. Each of the structural elements 24 shown should form a corresponding opening in the resist layer 14 on the semiconductor wafer 10 during the patterning. Therefore, the pattern of the mask could be transferred in an exposure step during the lithographic projection.

However, other lithographic concepts, requiring a plurality of exposure steps, are also known in the art, wherein multiple exposures of different overall patterns 22 are performed on different photomasks 18. However, exposures are also performed given different exposure settings with only a single photomask 18 for a corresponding patterning procedure, such as, e.g., an exposure technique which uses a plurality of different depth of focus settings of the exposure apparatus 5. Furthermore, it is also conceivable, for a pattern 22 to be provided which does not enable a direct assignment of a structural element of the pattern on the mask with the image on the resist layer. This is applied, e.g., in the case of photomasks whose image is formed by superposition of different contributions similarly to a hologram. These photomasks have a mask structure, e.g., a Fresnel lens. The method according to the invention can be applied to any one of, but not limited to, the lithography concepts mentioned above, and it will be understood that the invention is not limited to the exemplary embodiment described below involving an individual contact hole plane.

In accordance with this embodiment, operation 102 involves providing a plurality of basic patterns. The individual ones of basic patterns comprise a specific number of structural elements 24 in a specific arrangement as geometric primitives. As described herein, geometric primitives are to be understood as the geometric arrangement of the structural elements 24, which is determined, e.g., on the basis of the outer line enclosing the structural elements 24. The outer line may for example enclose a basic pattern in the form of, but not limited to, a rectangle, a square or some general form of polygon, comprising at least one structural element 24.

For this purpose, first the entire overall pattern 22 of structural elements 24 is searched for recurring parts, a surrounding window which must be free of other structural elements being defined for each basic pattern. Thus, in FIG. 3, the basic patterns 30 and 32 have been identified as recurring patterns. The basic patterns are determined for example with the aid of a special program by a data processing system and are subsequently stored in the data processing system.

In the case of relatively small circuit designs, it is also possible for procedure of creating the basic patterns to be performed manually, for example by a layout engineer.

In the next operation 104, the predetermined basic patterns are used for a decomposition of the pattern 22 of the circuit design. Therefore, the initially provided basic patterns 30 and 32 are progressively applied to the circuit design. For each basic pattern, the outer dimensions of the basic pattern are first determined to define a working region. A surrounding region that completely surrounds the working region is subsequently defined. In this case, the surrounding region is chosen such that structural elements outside the surrounding region, in the case of a lithographic projection, do not influence the basic pattern lying in the working region.

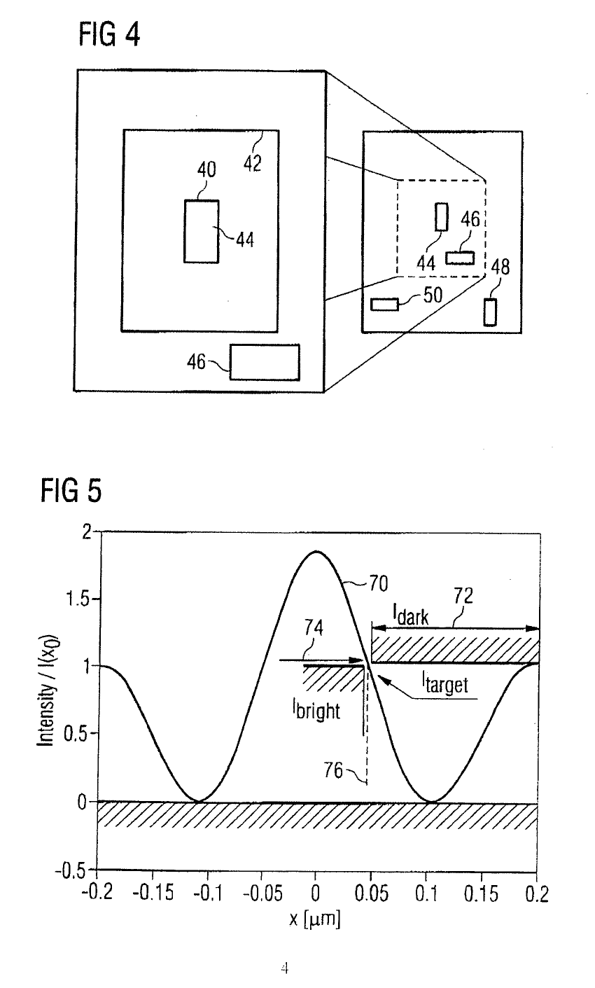

This is shown in more detail again in FIG. 4. Arrangements 44, 46, 48, and 50 of structural elements 24 are shown by way of example in FIG. 4. The basic pattern 30 corresponds to the arrangement 44 lying within the working region 40. The surrounding region 42 extends as a rectangular window around the basic pattern 30. The structural elements in arrangement 46 lie outside the surrounding region 42. Consequently, in the case of a lithographic projection, these structural elements will not influence the basic pattern 30 lying in the working region 42.

For the purpose of decomposing the circuit design, the basic pattern is compared with parts of the pattern of the plurality of structural elements in the working region. It is subsequently examined whether further structural elements lie in the surrounding region. In FIG. 2, the basic patterns 30 and 32 are consequently allocated to the structural elements lying in the upper part of the circuit design.

Those parts of the pattern of the plurality of structural elements in the case of which there is a match with the basic pattern are classified by marking or removing parts found in the circuit design.

The marking may be effected, e.g., by an individual numerical value or by a hash function in which each basic pattern is assigned a unique number, which facilitates the later assignment particularly when there are numerous basic patterns.

In the case where a match is absent, each basic pattern is subsequently subjected to a geometric transformation. Subsequently, the non-classified part of the circuit design is compared anew with the basic pattern formed on the basis of the geometric transformation. The geometric transformation may be a mirroring of the basic pattern at an axis of symmetry or a rotation through a specific angle, for example 90°. Consequently, in the exemplary embodiment in accordance with FIG. 3, the basic pattern 32′ that has resulted from a rotation of the basic pattern 32 is allocated to that part of the pattern which lies in the central, lower region of the circuit design.

Furthermore, in operation 106, the remaining part of the pattern that was not previously classified in operation 104 is assigned to one or a plurality of further basic patterns to obtain a completely classified pattern of the circuit design. In the exemplary embodiment in accordance with FIG. 3, the basic pattern 34 is consequently formed and assigned to the structural elements lying in the lower left-hand region.

Operation 108 subsequently involves applying a specification for optimizing the geometry of the structural elements 24 of the basic patterns 30, 32, 32′, and 34. For this purpose, the structural elements 24 are altered in a targeted manner for the OPC correction by calculating OPC structures for the structural elements 24.

In order to determine the targeted alteration of the structural elements 24 that is to be applied, it is customary to calculate the pattern of the circuit design during the photolithographic projection onto the resist layer 14 by a simulation program. The invention is not limited to selection or determination of the size and form of the OPC structures.

All of the methods mentioned in the introduction can be applied for determining OPC structures, thus, e.g., determining the OPC structures by optimizing the structure-imparting edges of the structural elements 24 of each basic pattern 30, 32, 32′, or 34. Furthermore, the structure-imparting edges of the structural elements 24 of each basic pattern 30, 32, 32′, and 34 may be determined by a rule-based or model-based OPC optimization.

The method in accordance with this exemplary embodiment proves to be particularly advantageous if the determination of the structure-imparting edges of the structural elements of each basic pattern 30, 32, 32′, and 34 is described as a numerical optimization problem of an imaging in the case of a lithographic projection by the projection apparatus 5, to perform the optimization for altering the geometry of the structural elements 24 of each basic pattern 30, 32, 32′, or 34. For this purpose, by way of example, the geometry of the structural elements 24 and the exposure conditions of the exposure source 16 are optimized simultaneously, as is shown in the document by A. Rosenbluth. A corresponding pupil aperture is calculated, by way of example, for the selection of the exposure conditions of the exposure source 16.

Optionally, it is also possible to use intensity distributions of the interference patterns for simultaneously optimizing the geometry of the structural elements and the exposure conditions of the exposure source 16 of the projection apparatus 5, as is described in the document by R. Socha. It is also conceivable to use an analytical optimization function comprising the weighted contributions of a linewidth deviation, a gradient of intensity profiles, higher-order light diffractions and the total number of the structural elements 24 of the respective basic pattern 30, 32, 32′ or 34 in order to carry out a non-analytical global optimization by means of genetic algorithms. This procedure has been described in the publication by A. Erdmann.

In general, all possible OPC simulations can be applied according to the invention, it being possible to calculate the OPC structures with a short computational time on account of the decomposition of the circuit design into individual basic patterns.

According to the invention, it is also possible to apply OPC simulations based on different algorithms or models to different regions of the circuit design. For this purpose, the pattern 22 of the circuit design is divided into two or more regions. The division may be effected for example according to a differentiation between a critical (i.e., for example close to the resolution limit of the projection apparatus 5) pattern of a part of the circuit design and a pattern of a part of the circuit design that is less critical for the corresponding lithography step. An OPC correction according to one of the customary concepts may then be performed for the less critical part of the circuit design, while the critical part is processed using novel OPC models mentioned above.

Operation 110 involves inserting the optimized basic patterns into the circuit design, thus achieving an improvement of the optical imaging properties when transferring the pattern of the circuit design onto a semiconductor wafer in the case of a lithographic projection.

In the previous exemplary embodiment, the decomposition of the circuit design into individual basic patterns was performed in order, subsequently, to determine OPC structures. According to the invention, however, it is also possible to determine non-imaging auxiliary structures that are not usually calculated in the context of an OPC modeling.

Non-imaging auxiliary structures contribute to producing the desired image. Under certain circumstances, however, the non-imaging auxiliary structures are not to be assigned directly to an image. The actual image at the location of the resist layer 14 arises through interference of all the imaging structures in the case of the lithographic projection.

For this purpose, provision is first made of a simulation program of the optical imaging in the case of the lithographic projection by the projection apparatus 5 onto the resist layer 14 applied on the semiconductor wafer 10. For this purpose, the simulation programs mentioned above or some other suitable simulation program may be used, by way of example.

The simulation program of the optical imaging is subsequently applied to individual ones of the basic patterns 30, 32, 32′, and 34 to determine an aerial image at the location of the resist layer 14. From the aerial image, an intensity profile is calculated for each basic pattern 30, 32, 32′, and 34.

One example of this simulation result is shown in FIG. 5 as intensity profile 70 as a function of the position X on the semiconductor wafer 10. Regions 72 which are intended to be imaged dark are produced on account of the arrangement of the structural elements 24. For this purpose, the light intensity must lie below a specific threshold I_{dark} in order to prevent leaving any structures on the resist layer 14. Further regions 74 that are intended to be imaged bright are likewise produced, and there the light intensity is intended to lie above a specific threshold I_{bright}. Moreover, it is possible to define positions 76 wherein the light intensity is intended to have a specific value I_{target}.

In order to ascertain whether the light intensity satisfies these conditions depending on the position of the structural elements 24 of the basic pattern, the intensity profile 70 is compared with the structural elements 24 of the basic pattern. If these conditions are not satisfied, auxiliary structural elements are subsequently provided. The non-imaging auxiliary structures are optimized with regard to the dimensions and the position with respect to the associated structural element of the basic pattern in order to satisfy the aforementioned conditions. The optimized non-imaging auxiliary structures are subsequently inserted into the basic pattern. As a result, regions to be imaged dark are imaged below a threshold, regions to be imaged bright are imaged above a specific threshold, and positions with a predetermined intensity value are imaged with this value.

Furthermore, it is also possible to determine the non-imaging auxiliary structures as a function of an intensity fluctuation, a defocus aberration in the projection apparatus 5, and a variation of the fluctuations of the mask geometry of the photomask 28 with regard to their minimum size or their minimum distance with respect to structural elements. It is thus possible to take account of fluctuations in the production of the photomask 18, the exposure conditions in the projection apparatus 5 or boundary conditions in the production of the photomask 18.

This procedure of determining non-imaging auxiliary structures may also be combined with the determination of OPC structures. For this purpose, it is possible for example to calculate error vectors for each structural element 24 of the basic pattern 30, 32, 32′ or 34. These error vectors may be determined on the basis of a comparison of the intensity profile 70 with the structural elements 24 of the respective basic pattern. As a result, an error distance and an error gradient are obtained, which can be employed for optimizing the geometry of the structural elements of the basic pattern.

While the invention has been described in detail and with reference to specific embodiments thereof, it will be apparent to one skilled in the art that various changes and modifications can be made therein without departing from the spirit and scope thereof. Accordingly, it is intended that the present invention covers the modifications and variations of this invention provided they come within the scope of the appended claims and their equivalents.

### LIST OF REFERENCE SYMBOLS

5 Projection apparatus
10 Semiconductor wafer
12 Substrate holder
14 Resist layer
16 Light source
18 Reticle
20 Projection objective
22 Pattern
24 Structural element
26 Cell
26′Cell
26″ Cell
30 Basic pattern
32 Basic pattern
32′ Basic pattern
34 Basic pattern
40 Working region
42 Surrounding region
44 Arrangement of structural elements
46 Arrangement of structural elements
48 Arrangement of structural elements
50 Arrangement of structural elements
70 Intensity profile
72 Dark imaging region
74 Bright imaging region
76 Position
100-110 Method operations

What is claimed is:

1. A method for optimizing the geometry of structural elements of a pattern of a circuit design to improve optical imaging properties, comprising:
(a) providing an electronically stored circuit pattern of the circuit design, the circuit pattern comprising a plurality of structural elements;
(b) providing a plurality of basic patterns, wherein individual ones of the basic patterns comprise a specific number of structural elements in a specific arrangement as geometric primitives;
(c) iteratively decomposing the circuit pattern into corresponding basic patterns by progressively performing the following for each basic pattern:
(c1) defining a working region by determining external dimensions of the geometric primitives of the basic pattern;
(c2) defining a surrounding region that completely surrounds the working region;
(c3) comparing the basic pattern with parts of the circuit pattern in the working region and examining the surrounding region to determine whether further structural elements lie in the surrounding region; and
(c4) classifying those parts of the circuit pattern in which a match exists with the basic pattern and no structural elements lie in the surrounding region that influence a lithographic projection of the circuit pattern lying in the working region;
(d) determining further basic patterns based on those parts of the circuit pattern not classified in (c), thus obtaining a fully classified circuit pattern;
(e) applying a specification for optimizing the geometry of the structural elements of each basic pattern; and
(f) inserting optimized basic patterns into the circuit design to improve of the optical imaging properties of the circuit pattern transferred onto a semiconductor wafer via lithographic projection.

2. The method according to claim 1, wherein (a) includes providing the electronically stored circuit pattern in which the structural elements of the circuit pattern comprise geometric elements of a photomask for single or multiple exposures or structural elements of a plurality of masks which, in progressive exposures of a lithographic projection, are superposed to form an overall image.

3. The method according to claim 1, wherein (b) includes searching for parts of the circuit pattern that are recurring and creating basic patterns based on the recurring parts of the circuit pattern.

4. The method according to claim 3, wherein creating basic patterns is performed based on rules that are stored in a program in a data processing system.

5. The method according to claim 1, wherein (c3) includes subjecting the basic pattern to a geometric transformation when a match is absent and repeating (c3) with the basic pattern formed from the geometric transformation.

6. The method according to claim 5, wherein the geometric transformation comprises a mirroring of the basic pattern at an axis of symmetry or a rotation through a predetermined angle.

7. The method according to claim 6, wherein the geometric transformation comprises rotation through an angle of 90°.

8. The method according to claim 1, wherein (c4) includes marking the parts that are found to match with the basic pattern.

9. The method according to claim 8, wherein marking the parts comprises employing a hash function.

10. The method according to claim 1, wherein (c4) includes removing the parts for which a match with the basic pattern is found.

11. The method according to claim 1, wherein (a) includes providing structural elements that represent contract hole openings for an integrated circuit.

12. The method according to claim 1, wherein (a) includes providing structural elements that are arranged in essentially recurring fashion and represent a layer of an integrated circuit.

13. The method according to claim 1, wherein (c) further includes defining the working regions for each basic pattern such that the working regions for the parts of the circuit design that match a basic pattern do not overlap.

14. The method according to claim 1, wherein (c2) including defining the surrounding region such that, for lithographic projection, structural elements situated outside the surrounding region have no influence on the imaging properties of the structural elements within the working region.

15. The method according to claim 1, wherein (e) includes determining OPC structures and/or auxiliary structures.

16. The method according to claim 15, wherein determining the OPC structures comprises includes optimizing structure-imparting edges of the structural elements of each basic pattern.

17. The method according to claim 16, wherein optimizing the structure-imparting edges comprises applying a rule-based OPC optimization.

18. The method according to claim 16, wherein optimizing the structure-imparting edges of the structural elements comprises applying a model-based OPC optimization.

19. The method according to claim 16, wherein the optimizing the structure-imparting edges comprises describing a numerical optimization problem of lithographic projection imaging to optimize alteration of the geometry of the structural elements of each basic pattern.

20. The method according to claim 19, wherein the numerical optimization problem of the imaging comprises applying genetic algorithms for simultaneously optimizing the geometry of the structural elements and calculating conditions of an exposure source via a corresponding pupil aperture.

21. The method according to claim 19, wherein the numerical optimization problem of the imaging comprises applying intensity distributions of the interference patterns for simultaneously optimizing geometry of the structural elements and the exposure conditions of an exposure source.

22. The method according to claim 19, wherein the numerical optimization problem of the imaging comprises applying an analytical optimization function that includes weighted contributions of a linewidth deviation, a gradient of intensity profiles, higher-order light diffractions, and the total number of the structural elements of the respective basic pattern to perform a non-analytical global optimization.

23. The method according to claim 1, further comprising:
(g) providing a simulation program of the optical imaging via lithographic projection onto a resist layer applied on a semiconductor wafer;
(h) applying the simulation program of the optical imaging for individual ones of the basic pattern to determine an intensity profile of an aerial image for the resist layer;
(i) comparing the intensity profile with the structural elements of the basic pattern to determine whether the intensity lies below a specific threshold in regions that are to be imaged dark, wherein auxiliary structural elements being inserted in regions which lie above the threshold;
(j) providing non-imaging auxiliary structures for each structural element of the basic pattern whose intensity profile lies above the threshold;
(k) comparing the intensity profile with the structural elements of the basic pattern to determine whether the intensity lies above a specific threshold in regions that are to be imaged bright, wherein auxiliary structural elements being inserted in regions which lie below the threshold;
(l) providing further non-imaging auxiliary structures for each structural element of the basic pattern whose intensity profile lies below the threshold;
(m) optimizing the non-imaging auxiliary structures with regard to dimensions and position with respect to a corresponding structural element of the basic pattern; and
(n) inserting the optimized non-imaging auxiliary structures into the basic pattern.

24. The method according to claim 23, wherein optimizing geometries of the structural elements of the basic pattern comprises:
calculating error vectors for each structural element of the basic pattern with regard to the comparison of the intensity profile with the structural elements of the basic pattern to determine an error distance and an error gradient; and
optimizing the geometry of the structural elements of the basic pattern based on a minimization of the error vectors.

25. The method according to claim 24, wherein the non-imaging auxiliary structures are determined as a function of an intensity fluctuation, a defocus aberration in a projection apparatus, and/or a variation of the production-dictated fluctuations of the mask geometry of a photomask.

26. The method according to claim 25, wherein the non-imaging auxiliary structures are determined with regard to their minimum size or their minimum distance with respect to structural elements.

27. The method according to claim 1, wherein the circuit pattern is divided into at least two regions, each part of the pattern being allocated a dedicated specification for improving the transfer of the circuit pattern of the part of the circuit design onto a semiconductor wafer via lithographic projection.

28. A method for producing a photomask, comprising:
storing optimized basic patterns generated according to claim 1 as an optimized circuit pattern of the circuit design; and
transferring the stored optimized circuit pattern onto a mask.
